(19) United States
(12) Patent Application Publication
(10) Pub. No.: US 2024/0201483 A1
(43) Pub. Date: Jun. 20, 2024

(54) OPTICAL SCANNING DEVICE AND IMAGE FORMING APPARATUS

(71) Applicant: SHARP KABUSHIKI KAISHA, Osaka (JP)

(72) Inventors: ATSUO NAKAO, Osaka (JP); HIROSHI YAMAMOTO, Osaka (JP); ATSUSHI UEDA, Osaka (JP)

(21) Appl. No.: 18/385,207

(22) Filed: Oct. 30, 2023

(30) Foreign Application Priority Data
Dec. 16, 2022 (JP) 2022-201420

(51) Int. Cl. G02B 26/12; G03G 15/043

(52) U.S. Cl. CPC G02B 26/124; G02B 26/125; G03G 15/043; G02B 3/06

(57) ABSTRACT

According to an embodiment, in an exposure unit in which beams of semiconductor lasers on one side, which serve as a first light source, and beams of semiconductor lasers on the other side, which serve as a second light source, are made incident on a polygon mirror from both sides of the polygon mirror, the beams of the first light source and the second light source are incident on the polygon mirror from positions on the opposite side of the first light source and the second light source in a main scanning direction with respect to the polygon mirror.

### BACKGROUND OF THE INVENTION

### Field of the Invention

The present disclosure relates to an optical scanning device and an image forming apparatus provided with the optical scanning device.

### Description of the Background Art

In an electrophotographic image forming apparatus, latent image writing is performed by an optical scanning device using a photoreceptor drum as an object to be scanned. Some optical scanning devices include ones in which scanning optical systems are arranged on both the left and right sides of a rotary polygon mirror, which serves as a deflector, such that the rotary polygon mirror is interposed between the scanning optical systems (which may hereinafter be referred to as a both-side scanning optical system).

Although the optical scanning device of the both-side scanning optical system is advantageous in reducing the size of the device, there is a problem in which a sufficiently long incident optical path length to the rotary polygon mirror cannot be secured within the device.

The present disclosure has been made in view of the problem described above, and an object of the present disclosure is to provide an optical scanning device of a both-side scanning optical system in which a sufficiently long incident optical path length can be secured, and an image forming apparatus provided with the same.

### SUMMARY OF THE INVENTION

In order to solve the above problem, an optical scanning device, which is a first aspect of the present disclosure, relates to an optical scanning device in which beams of a first light source and a second light source are made incident on a rotary polygon mirror from both sides of the rotary polygon mirror, and the optical scanning device is characterized in that the beams of the first light source and the second light source are incident on the rotary polygon mirror from positions on the opposite side of the first light source and the second light source in a main scanning direction with respect to the rotary polygon mirror.

According to the configuration described above, an optical path can be formed also in a space on the opposite side of the first light source and the second light source with the rotary polygon mirror interposed therebetween, and it is possible to extend an incident optical path length by effectively utilizing the space.

Further, the above-described optical scanning device may be configured such that the beams of the first light source and the second light source intersect with each other at a position on the opposite side of the first light source and the second light source in the main scanning direction with respect to the rotary polygon mirror.

According to the configuration described above, by making two kinds of beams intersect with each other, the two kinds of beams are to exist in the same space, and an optical path in which the space is effectively utilized can be formed.

Furthermore, the above-described optical scanning device may be configured such that the beams of the first light source and the second light source are reflected by a first reflecting mirror and a second reflecting mirror, respectively, and are made incident on the rotary polygon mirror, and the first reflecting mirror and the second reflecting mirror are arranged on a side opposite to the first light source and the second light source in the main scanning direction with respect to the rotary polygon mirror.

Furthermore, the above-described optical scanning device may be configured such that the beam incident on the rotary polygon mirror is made incident from a side opposite to a side on which each of the first light source and the second light source is arranged with respect to a straight line which passes through a rotation axis of the rotary polygon mirror and is parallel to the main scanning direction when viewed from a sub-scanning direction.

According to the configuration described above, it is possible to extend an optical path length also in a direction orthogonal to the main scanning direction.

Furthermore, the above-described optical scanning device may be configured such that the first reflecting mirror and the second reflecting mirror are arranged on both sides of a straight line which passes through a rotation axis of the rotary polygon mirror and is parallel to the main scanning direction when viewed from a sub-scanning direction.

According to the configuration described above, an optical path can be formed between the first reflecting mirror and the second reflecting mirror, and the optical path length can be extended in the direction orthogonal to the main scanning direction.

Furthermore, the above-described optical scanning device may be configured such that the optical scanning device includes a cylindrical lens, and the cylindrical lens is disposed at a position on the opposite side of the first light source and the second light source in the main scanning direction with respect to the rotary polygon mirror.

According to the configuration described above, it is possible to secure a distance from a semiconductor laser (the light source) to the cylindrical lens.

Furthermore, in order to solve the above problem, an image forming apparatus, which is a second aspect of the present disclosure, is characterized by including the optical scanning device described above.

In the optical scanning device and the image forming apparatus of the present disclosure, an optical path is formed in a space on the opposite side of the first light source and the second light source with the rotary polygon mirror interposed therebetween. By this feature, the optical scanning device and the image forming apparatus of the present disclosure exhibit the advantage of being able to extend the incident optical path length by effectively utilizing the space.

### BRIEF DESCRIPTION OF THE DRAWINGS

FIG. 1 is a schematic configuration diagram of an image forming apparatus to which an optical scanning device of the present disclosure can be applied.

FIG. 2 is a perspective view showing the internal structure of an exposure unit of the present disclosure.

FIG. 3 is a cross-sectional view of an optical system illustrated in FIG. 2 as seen from the side opposite to a semiconductor laser.

FIG. 4 is a cross-sectional view of the optical system illustrated in FIG. 2 as seen from the semiconductor laser side.

FIG. 5 is a top view of the optical system illustrated in FIG. 2.

FIG. 6 is a top view illustrating an optical system of an exposure unit in which a second reflecting mirror is omitted.

### DESCRIPTION OF THE PREFERRED EMBODIMENTS

### Embodiment 1

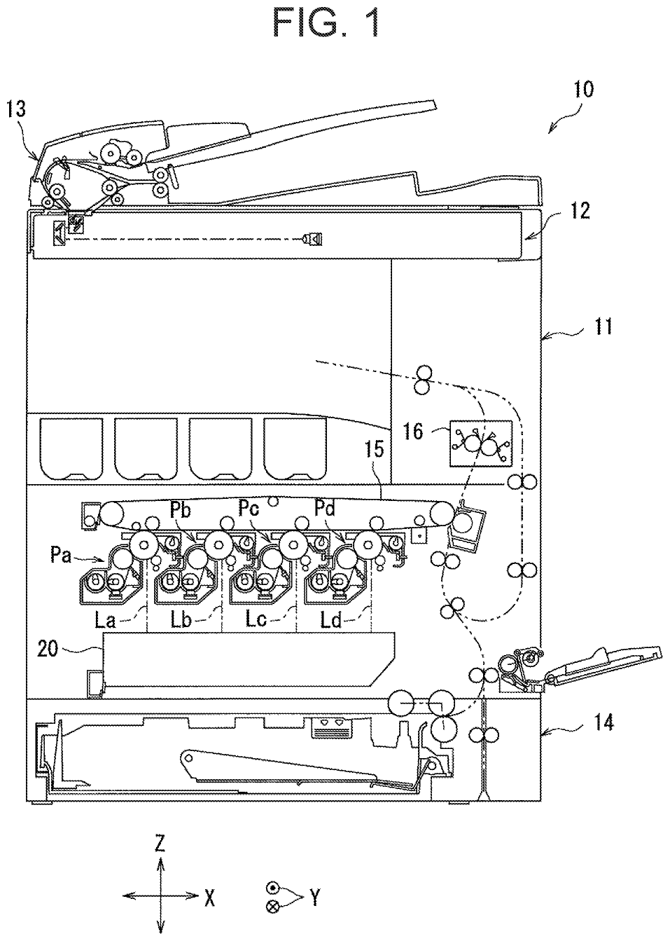

Hereinafter, an embodiment of an optical scanning device and an image forming apparatus of the present disclosure will be described in detail with reference to the drawings. FIG. 1 is a schematic configuration diagram of an image forming apparatus 10 to which the optical scanning device of the present disclosure can be applied. The image forming apparatus 10 illustrated in FIG. 1 is a tandem-type color image forming apparatus including a plurality of process units.

As illustrated in FIG. 1, the image forming apparatus 10 is constituted by including a main body part 11, a document reader 12, a document conveyance device 13, and a paper feeding device 14. The main body part 11 includes therein an image former for printing an image on a sheet of recording paper. The document reader 12 is arranged above the main body part 11, and reads a document when the document is to be copied. In an automatic reading mode, the document conveyance device 13 sequentially conveys documents that are placed on a document set tray toward a document placement table of the document reader 12. The paper feeding device 14 is provided with at least one paper feed cassette in which sheets of recording paper are stocked, and the paper feeding device 14 separates the sheets of recording paper one by one from the selected paper feed cassette and conveys the recording paper toward the main body part 11. In the main body part 11, an image is formed on the recording paper sent from the paper feeding device 14.

Image data to be handled in the image forming apparatus 10 is one corresponding to a color image using colors, i.e., black (K), cyan (C), magenta (M), and yellow (Y), or one corresponding to a monochrome image using a single color (e.g., black). Therefore, the image forming apparatus 10 includes, as the image former, four process units Pa, Pb, Pc, and Pd, which are associated with yellow, magenta, cyan, and black. Each of the process units Pa, Pb, Pc, and Pd forms a toner image corresponding to the image data by using well-known electrophotographic technology.

The toner images respectively formed by the process units Pa, Pb, Pc, and Pd are sequentially transferred to and superimposed on an intermediate transfer belt 15. A colored toner image is thus formed on the intermediate transfer belt 15. The colored toner image on the intermediate transfer belt 15 is transferred onto the recording paper, and a fusing unit 16 heats and pressurizes the recording paper to fuse the colored toner image on the recording paper.

In each of the process units Pa, Pb, Pc, and Pd, a latent image is written on a photoreceptor drum in the process of image formation. Thus, the image forming apparatus 10 is provided with an exposure unit (an optical scanning device) 20. In the following, a configuration of the exposure unit 20 will be described in detail.

As illustrated in FIG. 1, the exposure unit 20 is provided in common to the process units Pa, Pb, Pc, and Pd, and four beams of scanning light La, Lb, Lc, and Ld are output from a single unit. Here, the beams of scanning light La, Lb, Lc, and Ld correspond to the process units Pa, Pb, Pc, and Pd, respectively.

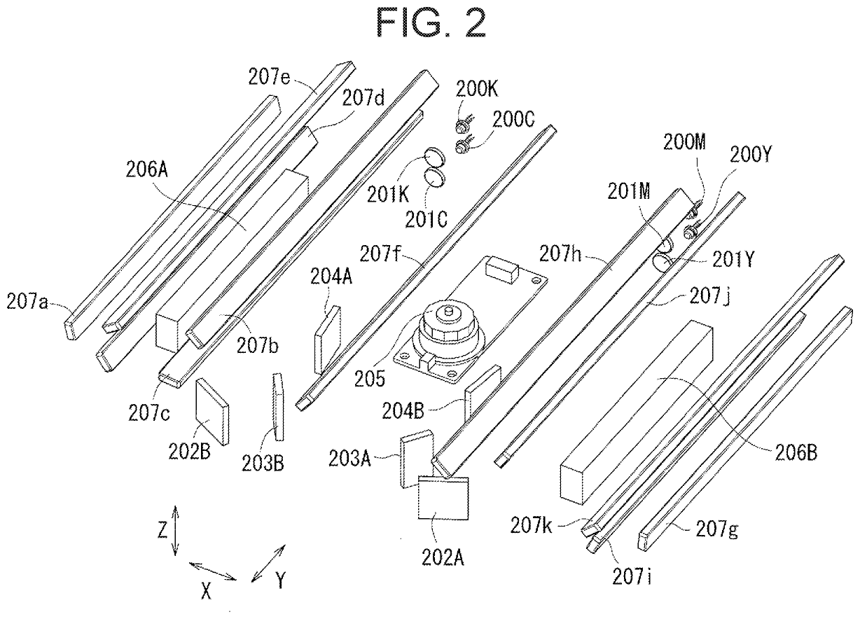

FIG. 2 is a perspective view showing the internal structure of the exposure unit 20 of the present disclosure. In FIG. 2, an external housing of the exposure unit 20 is omitted from illustration, and only the optical system inside the exposure unit 20 is illustrated. In FIG. 2, X-axis direction indicates a width direction of the exposure unit 20 and corresponds to a left-right direction of the image forming apparatus 10. Y-axis direction indicates a depth direction of the exposure unit 20 and corresponds to a front-rear direction of the image forming apparatus 10. Z-axis direction indicates a height direction of the exposure unit 20 and corresponds to an up-down direction of the image forming apparatus 10. Further, in the exposure unit 20, the Y-axis direction agrees with a main scanning direction of scanning light applied by a polygon mirror (a rotary polygon mirror) 205 to be described later, and the Z-axis direction agrees with a sub-scanning direction.

As illustrated in FIG. 2, the exposure unit 20 includes four semiconductor lasers 200Y, 200M, 200C, and 200K (which may be collectively referred to as a semiconductor laser 200), four collimator lenses 201Y, 201M, 201C, and 201K (which may be collectively referred to as a collimator lens 201), two first reflecting mirrors 202A and 202B (which may be collectively referred to as a first reflecting mirror 202), two cylindrical lenses 203A and 203B (which may be collectively referred to as a cylindrical lens 203), two second reflecting mirrors 204A and 204B (which may be collectively referred to as a second reflecting mirror 204), the polygon mirror 205, two Fθ lenses 206A and 206B, and a plurality of turning mirrors 207a to 207k. Note that FIG. 2 does not illustrate all of the optical components included in the exposure unit 20, and some of the components (an aperture, a beam detection sensor, and the like) are omitted from illustration.

The semiconductor lasers 200Y, 200M, 200C, and 200K are light sources which emit beams that constitute the scanning light La, Lb, Lc, and Ld. Here, the semiconductor lasers 200Y, 200M, 200C, and 200K correspond to the beams of scanning light La, Lb, Lc, and Ld, respectively. In the exposure unit 20, it is assumed that an emission direction of the beam of the semiconductor laser 200 is parallel to the main scanning direction. The collimator lenses 201Y, 201M, 201C, and 201K correspond to the semiconductor lasers 200Y, 200M, 200C, and 200K, respectively, and convert the beams emitted from the respective semiconductor lasers 200 into parallel light.

The first reflecting mirror 202A, the cylindrical lens 203A, and the second reflecting mirror 204A are provided to correspond to the semiconductor lasers 200Y and 200M. The first reflecting mirror 202A reflects an optical path of the incident beam toward the second reflecting mirror 204A, and the second reflecting mirror 204A reflects the optical path of the incident beam toward the polygon mirror 205. The cylindrical lens 203A is disposed between the first reflecting mirror 202A and the second reflecting mirror 204A, and condenses the beam in the sub-scanning direction. Further, the Fθ lens 206A is also provided to correspond to the semiconductor lasers 200Y and 200M.

The first reflecting mirror 202B, the cylindrical lens 203B, and the second reflecting mirror 204B are provided to correspond to the semiconductor lasers 200C and 200K. The first reflecting mirror 202B reflects an optical path of the incident beam toward the second reflecting mirror 204B, and the second reflecting mirror 204B reflects the optical path of the incident beam toward the polygon mirror 205. The cylindrical lens 203B is disposed between the first reflecting mirror 202B and the second reflecting mirror 204B, and condenses the beam in the sub-scanning direction. Further, the Fθ lens 206B is also provided to correspond to the semiconductor lasers 200C and 200K.

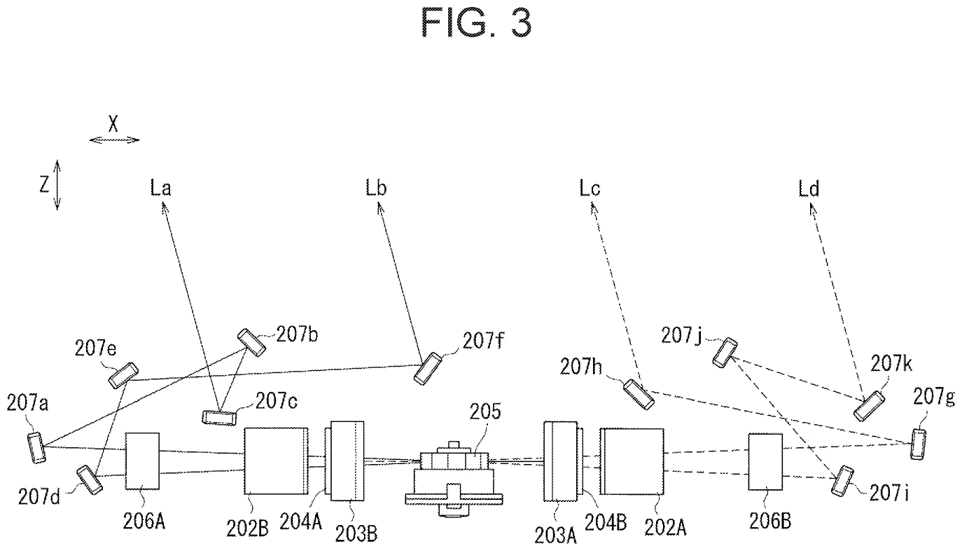

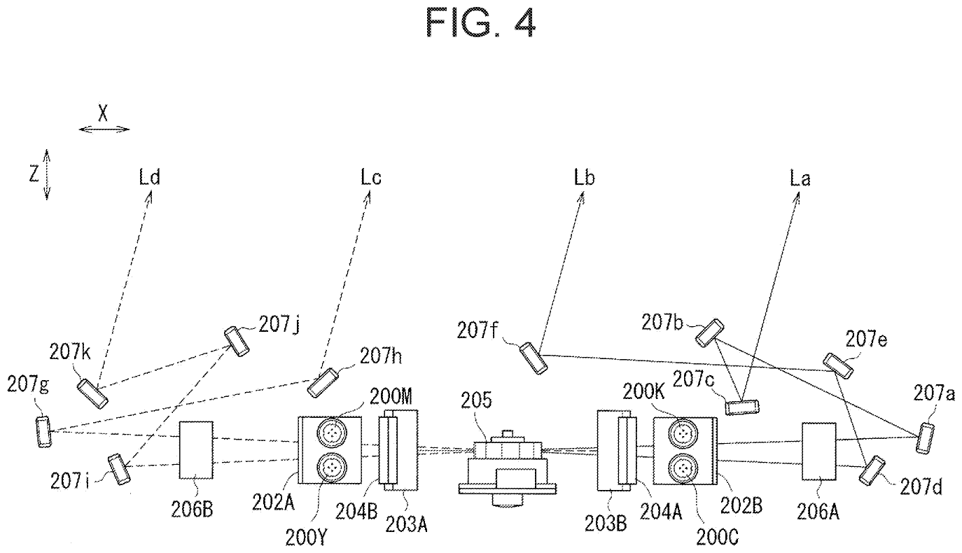

The turning mirrors 207a to 207k are mirrors for forming an optical path for emitting a beam deflected by the polygon mirror 205 as a beam of the scanning light La to Ld. FIG. 3 is a cross-sectional view of the optical system illustrated in FIG. 2 as seen from the side opposite to the semiconductor laser 200. FIG. 4 is a cross-sectional view of the optical system illustrated in FIG. 2 as seen from the semiconductor laser 200 side. In FIGS. 3 and 4, as regards optical paths of the respective beams of scanning light La to Ld, the optical paths corresponding to the semiconductor lasers 200Y and 200M (a first light source) are indicated by solid lines, and the optical paths corresponding to the semiconductor lasers 200C and 200K (a second light source) are indicated by broken lines. As illustrated in FIGS. 3 and 4, the turning mirrors 207a to 207c are used to form the optical path of the scanning light La, the turning mirrors 207d to 207f are used to form the optical path of the scanning light Lb, the turning mirrors 207g and 207h are used to form the optical path of the scanning light Lc, and the turning mirrors 207i to 207k are used to form the optical path of the scanning light Ld.

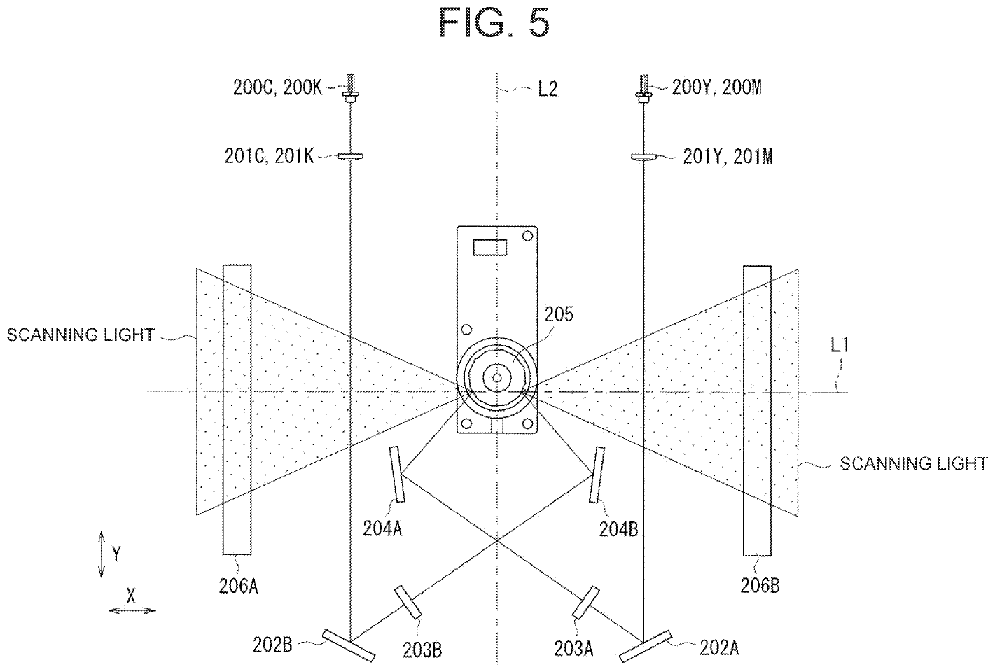

FIG. 5 is a top view of the optical system illustrated in FIG. 2. However, in FIG. 5, in order to simplify the figure, illustration of the turning mirrors 207a to 207k is omitted. L1 shown in FIG. 5 indicates a central optical axis of the scanning light in the main scanning direction when viewed from the Z-axis direction (the sub-scanning direction), and will herein be referred to as an optical reference. The optical reference L1 is, when viewed from the Z-axis direction, orthogonal to the Y-axis direction (the main scanning direction) and parallel to the X-axis direction. Further, L2 indicated in FIG. 5 is a straight line which passes through a rotation axis of the polygon mirror 205 and is, when viewed from the Z-axis direction, parallel to the Y-axis direction (the main scanning direction).

As illustrated in FIG. 5, the exposure unit 20 adopts a both-side scanning optical system in which scanning optical systems are arranged on both sides that are along the optical reference L1 with the polygon mirror 205 interposed therebetween. Here, two types of light sources arranged with the polygon mirror 205 interposed therebetween are referred to as the first source and the second light source. In FIG. 5, the semiconductor lasers 200Y and 200M on the right side of the polygon mirror 205 are the first light source, and the semiconductor lasers 200C and 200K on the left side of the polygon mirror 205 are the second light source. In other words, in the both-side scanning optical system, beams of the first light source and the second light source are made incident on the polygon mirror 205 from both sides in the direction (the X-axis direction) along the optical reference L1. In the example of FIG. 5, the direction along the optical reference LI is the left-right direction of the drawing, and the beam of the first light source is made incident on the polygon mirror 205 from the left side and the beam of the second light source is made incident on the polygon mirror 205 from the right side. In FIG. 5, although the semiconductor lasers 200, the collimator lenses 201, the first reflecting mirrors 202, the cylindrical lenses 203, and the second reflecting mirrors 204 are arranged to be bilaterally symmetric with respect to the straight line L2, the aforementioned elements may be arranged to be asymmetric.

In an exposure unit of a both-side scanning optical system, a physical distance between a semiconductor laser, which serves as a light source, and a polygon mirror, which serves as a deflector, is decreased (i.e., a space between the semiconductor laser and the polygon mirror is narrowed). In this case, when a beam emitted from the semiconductor laser is directly made incident on the polygon mirror, it is not possible to secure a sufficiently long incident optical path length to the polygon mirror. Therefore, it is possible that the performance of a lens used in the optical system may not be sufficiently exhibited.

In the exposure unit 20, a beam emitted from the semiconductor laser 200 is made incident on the polygon mirror 205 via the collimator lens 201, the first reflecting mirror 202, the cylindrical lens 203, and the second reflecting mirror 204. To be more specific, the beam emitted from the semiconductor laser 200 is first reflected by the first reflecting mirror 202 after traversing the optical reference L1, is further reflected by the second reflecting mirror 204 after traversing the straight line L2, and then is made incident on the polygon mirror 205.

Consequently, by including reflection by each of the first reflecting mirror 202 and the second reflecting mirror 204 in the optical path that is from the semiconductor laser 200 to the polygon mirror 205, it is possible for the exposure unit 20 to secure a sufficiently long incident optical path length even in a narrow space.

Specifically, in the exposure unit 20 according to the present embodiment, beams of the semiconductor lasers 200 (the first light source and the second light source) are made incident toward the polygon mirror 205 from both sides (i.e., both the left and right sides in FIG. 5), from positions on the opposite side of the semiconductor lasers 200 in the main scanning direction with respect to the polygon mirror 205. In other words, the position where the semiconductor laser 200 is arranged with respect to the polygon mirror 205 and the position of incidence of the beam onto the polygon mirror 205 are opposite to each other in the main scanning direction with respect to the polygon mirror 205. In the example of FIG. 5, the semiconductor laser 200 is arranged on the upper side relative to the polygon mirror 205, and the beam thereof is made incident onto the polygon mirror 205 from the lower side. As a result, the beam of the semiconductor laser 200 can form an optical path that traverses the optical reference L1 before being incident on the polygon mirror 205. Consequently, the semiconductor laser 200 in the exposure unit 20 can form an optical path also in a space on the opposite side of the semiconductor laser 200 in the main scanning direction with the polygon mirror 205 interposed therebetween, and it is possible to extend the incident optical path length to the polygon mirror 205 by effectively utilizing the space.

Further, in the exposure unit 20, the beams of the semiconductor lasers 200 intersect (cross) each other (that is, the beam of the first light source and the beam of the second light source intersect with each other) at a position on the opposite side of the semiconductor lasers 200 in the main scanning direction with respect to the polygon mirror 205. Specifically, the beam between the first reflecting mirror 202A and the second reflecting mirror 204A in the beam of the first light source intersects with the beam between the first reflecting mirror 202B and the second reflecting mirror 204B in the beam of the second light source. By making two kinds of beams intersect with each other in this way, the two kinds of beams are to exist in the same space, and an optical path in which the space is effectively utilized can be formed.

Further, in the exposure unit 20, the beam of the semiconductor laser 200 is reflected by the first reflecting mirror 202 and the second reflecting mirror 204, and is made incident on the polygon mirror 205. In this case, the first reflecting mirror 202 and the second reflecting mirror 204 are arranged on the opposite side of the semiconductor laser 200 across the optical reference L1 (or more specifically, on the side opposite to the semiconductor laser 200 in the main scanning direction with respect to the polygon mirror 205).

Further, in the exposure unit 20, the beam incident on the polygon mirror 205 is made incident from a side opposite to the side on which each of the semiconductor lasers 200 is arranged with respect to the straight line L2. Consequently, it is possible to extend the optical path length also in a direction orthogonal to the main scanning direction.

Also, in the exposure unit 20, the first reflecting mirror 202 and the second reflecting mirror 204 are disposed on both sides of the straight line L2. Consequently, an optical path can be formed between the first reflecting mirror 202 and the second reflecting mirror 204, and the optical path length can be extended in the direction orthogonal to the main scanning direction.

Furthermore, in the exposure unit 20, the cylindrical lens 203 is disposed at a position on the opposite side of the semiconductor lasers 200 in the main scanning direction with respect to the polygon mirror 205. This arrangement is to secure a distance from the semiconductor laser 200 to the cylindrical lens 203. In the exposure unit 20 in which the optical path length is extended, a degree of freedom of the arrangement of the cylindrical lens 203 is increased, and by arranging the cylindrical lens 203 as described above, an optically preferable distance can be easily secured between the semiconductor laser 200 and the cylindrical lens 203.

### Embodiment 2

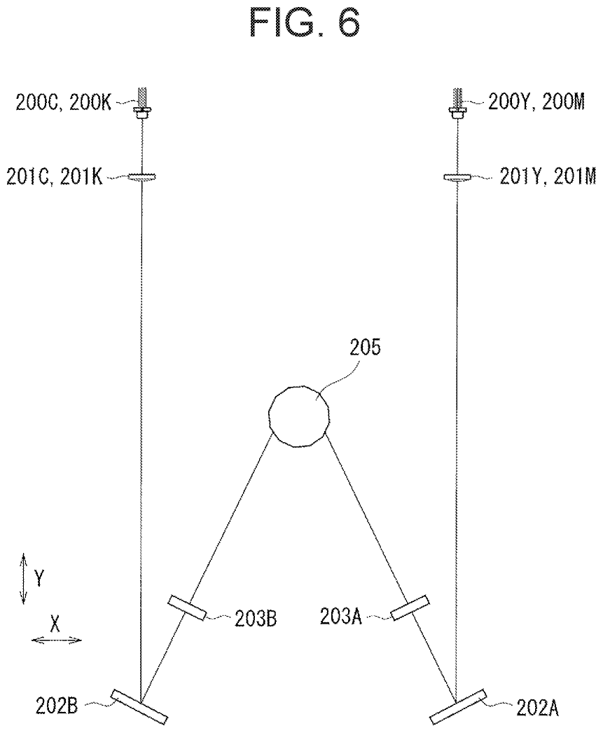

In Embodiment 1 described above, a beam emitted from the semiconductor laser 200 is brought to be incident on the polygon mirror 205 via the first reflecting mirror 202 and the second reflecting mirror 204. However, in the exposure unit 20 of the present disclosure, the second reflecting mirror 204 may be omitted. FIG. 6 is a top view illustrating an optical system of an exposure unit 20 in which a second reflecting mirror 204 is omitted. However, in FIG. 6, only the optical system constituted of elements, which are from the semiconductor laser 200 to the polygon mirror 205, is extracted and shown.

As illustrated in FIG. 6, even when the second reflecting mirror 204 is omitted, it is possible to extend the optical path in the main scanning direction (Y-axis direction) by means of the first reflecting mirror 202.

The embodiments disclosed herein are merely exemplary in all respects, and do not constitute grounds for restrictive interpretation. Accordingly, the technical scope of the present disclosure is not to be interpreted in terms of the embodiments described above alone, but is defined on the basis of the recitations of the claims. Further, all changes which come within the meaning and scope of the claims and their equivalents are to be embraced herein.

What is claimed is:

1. An optical scanning device in which beams of a first light source and a second light source are made incident on a rotary polygon mirror from both sides of the rotary polygon mirror, wherein
the beams of the first light source and the second light source are incident on the rotary polygon mirror from positions on an opposite side of the first light source and the second light source in a main scanning direction with respect to the rotary polygon mirror.

2. The optical scanning device according to claim 1, wherein the beams of the first light source and the second light source intersect with each other at a position on the opposite side of the first light source and the second light source in the main scanning direction with respect to the rotary polygon mirror.

3. The optical scanning device according to claim 1, wherein:
the beams of the first light source and the second light source are reflected by a first reflecting mirror and a second reflecting mirror, respectively, and are made incident on the rotary polygon mirror; and
the first reflecting mirror and the second reflecting mirror are arranged on a side opposite to the first light source and the second light source in the main scanning direction with respect to the rotary polygon mirror.

4. The optical scanning device according to claim 1, wherein the beam incident on the rotary polygon mirror is made incident from a side opposite to a side on which each of the first light source and the second light source is arranged with respect to a straight line which passes through a rotation axis of the rotary polygon mirror and is parallel to the main scanning direction when viewed from a sub-scanning direction.

5. The optical scanning device according to claim 3, wherein the first reflecting mirror and the second reflecting mirror are arranged on both sides of a straight line which passes through a rotation axis of the rotary polygon mirror and is parallel to the main scanning direction when viewed from a sub-scanning direction.

6. The optical scanning device according to claim 1, comprising a cylindrical lens, wherein
the cylindrical lens is disposed at a position on the opposite side of the first light source and the second light source in the main scanning direction with respect to the rotary polygon mirror.

7. An image forming apparatus comprising the optical scanning device according to claim 1.
